(19) United States
(12) Patent Application Publication
(10) Pub. No.: US 2004/0157101 A1
(43) Pub. Date: Aug. 12, 2004

(54) Fuel cell electrode assembly

(76) Inventor: Stuart I. Smedley, Escondido, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/364,768

(22) Filed: Feb. 11, 2003

(51) Int. Cl. H01M 8/10; H01M 4/86; H01M 10/40; H01M 12/06

(52) U.S. Cl. 429/30; 429/33; 429/42; 429/314; 429/317; 29/623.3

(57) ABSTRACT

An improved electrode assembly for a fuel cell with a gaseous reactant comprises an active layer and a backing layer adhered to the active layer, in which the active layer comprises a catalyst, a matrix polymer and an ion-conducting polymer. The matrix polymer can form a porous polymer matrix in which the ion-conducting polymer is disposed. The backing layer comprises a hydrophobic polymer and a porous composite. A fuel cell stack can include one or more of the improved electrode assemblies.

### FIELD OF THE INVENTION

The invention relates to electrode assemblies for fuel cells, especially as cathodes for metal/air fuel cells. In particular, the invention relates to cathode assemblies with an active layer having an ion-conducting polymer. The invention further relates to methods for forming fuel cell electrode assemblies with ion-conducting polymers.

### BACKGROUND OF THE INVENTION

Gas diffusion electrodes are suitable for use in electrochemical cells that have gaseous reactants, including for use in the cathode for the reduction of oxygen, bromine or hydrogen peroxide. The reduction of gaseous molecular oxygen can be an electrode reaction, for example, in metal-air/oxygen batteries, metal-air/oxygen fuel cells and hydrogen-oxygen fuel cells. Oxygen is generally conveniently supplied to these electrochemical cells in the form of air. Similarly, the oxidation of gaseous molecular hydrogen can be the anode reaction in hydrogen oxygen fuel cells. Fuel cells differ from batteries in that the reactants for the anode and the cathode can both be replenished without disassembling the cells.

The cathode in an electrochemical cell containing an alkaline electrolyte and involving oxygen reduction, generally catalyses the reduction of oxygen, which combines with water to form hydroxide ions. The reduction of oxygen removes electrons at the cathode. The oxidation reaction at the anode gives rise to the electrons that flow to the cathode when the circuit connecting the anode and the cathode is closed. The electrons flowing through the closed circuit enable the foregoing oxygen reduction reaction at the cathode and simultaneously can enable the performance of useful work due to an over-voltage between the cathode and the anode. For example, in one embodiment of a fuel cell employing metal, such as zinc, iron, lithium and/or aluminum, as a fuel and potassium hydroxide as the electrolyte, the oxidation of the metal to form an oxide or a hydroxide release electrons. In some systems, a plurality of cells is coupled in series, which may or may not be within a single fuel cell unit, to provide a desired voltage. For commercially viable fuel cells, it is desirable to have electrodes that can function within desirable parameters for extended periods of time on the order of 1000 hours or even more.

Fuel cells are a particularly attractive power supply because they can be efficient, environmentally safe and completely renewable. Metal/air fuel cells can be used for both stationary and mobile applications, such as all types of electric vehicles. Fuel cells offer advantages over internal combustion engines, such as zero emissions, lower maintenance costs, and higher specific energies. Higher specific energies can result in weight reductions. In addition, fuel cells can give vehicle designers additional flexibility to distribute weight for optimizing vehicle dynamics.

### SUMMARY OF THE INVENTION

In a first aspect, the invention pertains to an electrode assembly comprising an active layer and a backing layer adhered to the active layer, where the active layer comprises a catalyst, a matrix polymer and an ion-conducting polymer. In this aspect, the matrix polymer forms a porous polymer matrix and the ion-conducting polymer is disposed within the pores of the polymer matrix. The backing layer comprises a hydrophobic polymer and particles within a porous composite.

In a further aspect, the invention pertains to a fuel cell stack comprising a cathode, an anode and a separator between the cathode and the anode, where the cathode comprises an active layer and a backing layer adhered to the active layer. Furthermore, the active layer comprises a catalyst, a matrix polymer and an ion-conducting polymer within the pores of a polymer matrix formed by the matrix polymer. The backing layer comprises a hydrophobic polymer and particles forming a porous composite.

In addition, the invention pertains to a method for forming a electrode assembly comprising an active layer and a backing layer. The method comprises instilling an ion conducting polymer within an active layer of an electrode assembly and laminating the backing layer to the active layer. The active layer comprises a catalyst and a matrix polymer in the form of a porous matrix into which the ion-conducting polymer is instilled. The backing layer comprises a hydrophobic polymer and particles within a porous water resistant composite.

### BRIEF DESCRIPTION OF THE DRAWINGS

FIG. 1 is a side view of an electrode comprising a catalyst, polymer binder and an ion-conducting polymer.

FIG. 2 is a schematic diagram of a metal-air fuel cell designed for the continuous replenishment of metal fuel, in which a sectional side view of an anode is shown in phantom lines.

FIG. 3 is a sectional view of the fuel cell of FIG. 2 showing a cathode, in which the section is taken along line 3-3 of FIG. 2.

FIG. 4 is a sectional side view of an electrode assembly with a current collector embedded within one layer of an electrode assembly comprising an electrode backing layer and an active electrode layer.

FIG. 5 is a sectional side view of an electrode assembly with a current collector embedded between layers of an electrode assembly comprising an electrode backing layer and an active electrode layer.

FIG. 6 is a sectional side view of an electrode assembly with a current collector embedded within the surface of one layer of an electrode assembly comprising an electrode backing layer and an active electrode layer, in which the current collector is embedded adjacent to the interface between the layers.

FIG. 7 is a sectional side view of an electrode assembly with a current collector embedded within the surface of one layer of an electrode assembly comprising an electrode backing layer and an active electrode layer, in which the current collector is embedded in the surface opposite the interface between the layers.

FIG. 8 is a sectional side view of an electrode assembly with a current collector attached along the free surface of one layer of an electrode assembly comprising an electrode backing layer and an active electrode layer.

### DETAILED DESCRIPTION OF THE INVENTION

Improved fuel cell electrode assemblies comprise active layers associated with backing layers in which the active layer comprises an ion-conducting polymer within the pores formed by a polymer matrix. Due to the presence of the ion-conducting polymer, the electrode assemblies provide a reduction or elimination of osmotic pressure within the electrode active layer as a result of ionization occurring within the electrode during fuel cell operation. The active layer further comprises catalyst particles which are suitable for catalyzing the reduction of oxygen, generally for the formation of hydroxide ions. The catalyst particles can be selected to conduct electricity, although the active layer can comprise additional electrically conductive particles. In some embodiments, the backing layer is laminated to the active layer. The backing layer generally comprises particles that facilitate the presence of pores at the end of the processing. The active layer and the backing layer are generally laminated to each other sufficiently to maintain the binding of the layers to each other even in the presence of fluid pressures within the fuel cell.

The active layer and backing layer of the gas diffusion electrodes are porous to gases such that gases can penetrate through the backing layer and into the active layer. However, the backing layer of the electrodes is generally sufficiently hydrophobic to prevent diffusion of the electrolyte solution into or through the backing layer. The matrix polymer of the active layer is porous, and the porosity of the matrix polymer is generally introduced during processing of the matrix polymer by the use of shear forces or pore forming agents. The ion-conducting polymer is instilled in the pores of matrix polymer. In some embodiments substantially all of the pores of the matrix polymer are filled, while in other embodiments only a portion of the pore are filled with ion-conducting polymer.

For example, the gas reactive electrodes are suitable as electrodes in batteries and fuel cells having a gaseous or liquid reactant, such as hydrogen, oxygen, bromine and/or peroxide. For example, hydrogen, methanol, metal or other fuel can be oxidized at the anode. The electrodes described herein are suitable for catalyzing the oxidation of gaseous hydrogen at the anode.

A metal fuel cell is a fuel cell that uses a metal, such as zinc particles, as fuel. In a metal fuel cell, the fuel is generally stored, transmitted and used in the presence of a reaction medium, such as potassium hydroxide solution. Specifically, in metal-air batteries and metal-air fuel cells, oxygen is reduced at the cathode, and metal is oxidized at the anode. In some embodiments, oxygen is supplied as air. For convenience, air and oxygen are used interchangeably throughout unless a specific context requires a more specific interpretation. The gas diffusion electrodes described herein are suitable for catalyzing the reduction of oxygen at a cathode in fuel cell or battery. The improved fuel cell electrode assemblies are particularly suited for use as cathodes in zinc-air fuel cells. A fuel cell differs from a battery in that the fuel can be replenished within a fuel cell or fuel cell stack without disassembling the fuel cell or fuel cell stack.

In metal-air fuel cells that utilize zinc as the fuel, the following reaction takes place at the anodes:

Zn 4OH o Zn(OH)₄² 2e (1)

The two released electrons flow through a load to the cathode where the following reaction takes place:

$$\frac{1}{2} {O}_{2} 2 e {H}_{2} O o 2 OH \qquad ( 2 )$$

The reaction product is the zincate ion, Zn(OH)₄², which is soluble in the reaction solution KOH. The overall reaction which occurs in the cell cavities is the combination of the two reactions (1) and (2). This combined reaction can be expressed as follows:

$$Zn 2 OH \frac{1}{2} {O}_{2} {H}_{2} O o {Zn ( OH )}_{4}^{2} \qquad ( 3 )$$

Alternatively, the zincate ion, Zn(OH)₄², can be allowed to precipitate to zinc oxide, ZnO, a second reaction product, in accordance with the following reaction:

Zn(OH)₄² o ZnO H₂O 2OH (4)

In this case, the overall reaction which occurs in the cell cavities is the combination of the three reactions (1), (2), and (4). This overall reaction can be expressed as follows:

$$Zn \frac{1}{2} {O}_{2} o ZnO \qquad ( 5 )$$

Under ambient conditions, the reactions (4) or (5) yield an open-circuit voltage potential of about 1.4 V. For additional information on this embodiment of a zinc/air battery or fuel cell, the reader is referred to U.S. Pat. Nos. 5,952,117; 6,153,329; and 6,162,555, which are hereby incorporated by reference herein as though set forth in full.

The reaction products of the above reactions can optionally be provided to a regeneration unit, which can reprocess the reaction products to yield oxygen and zinc particles. Specifically, the reaction product Zn(OH)₄² and/or possibly ZnO or other zinc compounds, can be reprocessed with the application of an external EMF, for example, from line voltage, to yield oxygen and zinc particles. The regenerated zinc particles can optionally be stored in a fuel storage unit. The fuel storage unit can be operably coupled to the fuel cells in order to supply the regenerated fuel to the electrodes.

It should be appreciated that embodiments of metal fuel cells other than zinc fuel cells or the particular form of zinc fuel cell described above are possible for use in a system according to the invention. For example, aluminum fuel cells, lithium fuel cells, magnesium fuel cells, iron fuel cells, sodium fuel cells, and the like are possible. The invention may also be applied to metal-air batteries of all types, and to batteries such as zinc-batteries.

In general, electrodes, and specifically cathodes for the reduction of oxygen in alkaline electrolytes, are usually comprised of three layers. The first layer is a porous active layer, which is infiltrated with a mixture of electrolyte and air/oxygen. The second layer is a backing layer that is placed between the active layer and the air flow. The backing layer is generally impervious to electrolyte, but permeable to gas. The third layer is an electrically conducting mesh that provides electrical contact with other cell components. Furthermore, the active layer is often comprised of a mixture of catalyzed carbon, and/or other catalyst particles, and a polymeric binder material, for example, Teflon®, where the polymeric binder material is processed in such a manner as to bind the catalyst into a porous layer.

Sections, or regions, of the active layer that contain more Teflon®, or other polymeric binding material, form hydrophobic zones and sections that contain less Teflon® form hydrophilic zones. Generally, the pores in the hydrophilic zones of the active layer contain, for example, potassium hydroxide electrolyte while the pores in the hydrophobic zone contain air or oxygen. The electrochemical reaction occurs at the interphase of the two zones. One possible electrochemical reaction is shown above in equation 2. In this reaction, water is consumed and hydroxide ions are produced. To reach the reaction site within the pores of the active layer water generally diffuses from the bulk of the electrolyte into the reaction zone. Due to the consumption of water and generation of hydroxide ions, the concentration of water in the electrolyte outside the active layer generally is higher than the concentration of water at the reaction zone. Furthermore, the concentration of hydroxide ions at the reaction zone is higher than in the bulk of the solution, which results in the migration of water into the reaction zone. The hydroxide ions diffuse out of the reaction zone into the bulk solution under the influence of the concentration gradient.

This difference in concentration of the potassium hydroxide between the reaction sites in the active layer and the bulk electrolyte solution adjacent to the active layer gives rise to osmotic pressure build up in the active layer. Furthermore, higher current densities lead to larger concentration gradients and ultimately produce greater osmotic pressures.

While not wanting to be limited by a particular theory, the osmotic pressure generated as a result of electrochemical activity can have a degenerative effect on the operating lifetime of the cathode. It is believed that the osmotic pressure drives the electrolyte further into the active layer, which over time can lead to the additional flooding of the active layer with electrolyte and loss of activity. It is also believed that the osmotic pressure can lead to expansion of the electrode and an increase in pore size of the active layer. This increase in pore size of the active layer allows the electrolyte to further penetrate into the pores and exacerbates the rate of flooding. This problem can be significantly reduced or eliminated by preventing the above-mentioned concentration gradient from forming. One way of preventing the concentration gradient from forming is by replacing the liquid electrolyte in the pores of the active layer with an ion-conducting polymer, such as a single-ion conducting polymer, or ion selecting polymer.

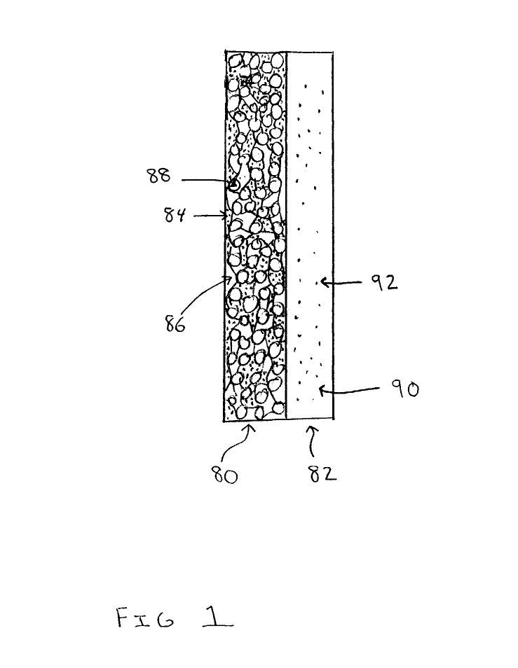

As shown in FIG. 1, the electrode composition of the present invention generally comprises a porous active layer 80 adhered to a backing layer 82. In one embodiment, the active layer 80 comprises a catalyst 84, a matrix polymer 86 and an ion-conducting polymer 88. In this embodiment, the matrix polymer 86 forms a porous polymer matrix and the ion-conduction polymer 88 is disposed within the pores of the polymer matrix. In one embodiment, the backing layer 82 comprises a second polymer 90 that is hydrophobic and particles 92 within a porous water-resistant composite. In addition, the electrode compositions of the present invention generally contain electrically conductive particles.

As will be described in more detail below, the matrix polymer can be any polymer suitable for forming a porous particle binder. More specifically, suitable matrix polymers for the electrode composition can be homopolymers, copolymers, block copolymers, polymer blends and mixtures thereof. Various polymers are suitable for porous electrode fabrication in fuel cells and batteries. In embodiments based on fibrillatable polymers, suitable polymers include, for example, fluorinated polymers and blends and mixtures thereof. In embodiments involving extrusion or molding, pore formers are agents that are compatible with the polymer in the sense that the pore former can be dispersed through the polymers mass and co-molded with the polymer. The pore former or a portion thereof is then removed to leave behind pores or voids in the locations at which the pores formers were located. In all of the embodiments, the particular components in the compositions and the processing conditions can be selected to yield particularly desired characteristics for resulting electrode material.

The ion-conducting polymer of the present invention can be any polymer capable of acting as an ion exchange polymer. In some embodiments, the ion selective polymer generally has the ability to readily transport water, since water is a reactant or a product depending on the electrochemical reactions. The ion-conducting polymer may or may not be selective only for hydroxide ions, or any other particular ion. For example, in some embodiments of the present invention, the ion-conducting polymer is a single-ion conducting polymer, such as an ion-conducting polymer selective for hydrogen ions.

The electrode structure generally is designed to prevent depletion of the water content of the electrolyte, which would lead to cell failure. In some embodiments for limiting the depletion of water, the electrode backing layer is positioned immediately adjacent to the active layer. Water at the cathode is inhibited by the backing layer from escaping into the air flow and permitted to diffuse back into the liquid electrolyte thereby maintaining the water content of the cell.

To form the electrodes, electrically conductive particles are included to provide the electrical conductivity. Generally, reasonably high loading levels can be used to obtain desired levels of electrochemical conductivity, as described further below. For gaseous reactants, catalysts can be included within the electrode material to catalyze the reaction of gaseous reactants. The hydrophobicity of the electrode composition can be controlled to correspondingly control the amount of wetting of the electrode by the electrolyte. The electrode backing layer can optionally include electrically conductive particles and can be gas permeable. However, the electrode backing layer generally is more hydrophobic such that the electrolyte/reaction medium does not penetrate past the backing layer. Thus, the electrode backing layer can form a barrier to electrolyte loss through evaporation and/or flow from the cell.

In general, the active layer and the backing layer of the electrode can be formed separately or simultaneously, for example, by coextrusion. In addition, the ion-conducting polymer can be added to the active layer during formation of the active layer structure or after the formation of the active layer structure. If the ion-conducting polymer is added to the active layer after formation of the active layer structure, the ion-conducting polymer generally can be added to the active layer before, during or after binding of the active layer to the backing layer. The active layer is generally bound to the backing layer, for example by lamination or the like.

In one embodiment, the active layer can be formed by initially producing a mixture, or a paste, that comprises catalyzed carbon particles, or other catalyst and/or electrically conductive particles, and a polymeric binder material. Similarly, for the formation of the backing layer, a binding polymer can be optionally combined with electrically conductive particles in a mixture. The mixture is generally formed into a porous sheet. For compression molding, a pore forming agent should be selected such that the liquid pore former does not phase separate from the polymer and remains well dispersed within the polymer. In other embodiments where the matrix polymer comprises a fibrillatable polymer, the desired level of porosity can be introduced by shear forces. Shear forces can be applied, for example, by extrusion and/or calendering. Methods of fibrillating polymers by calendering are described in commonly assigned and co-pending application Ser. No. 10/288,392 titled “Gas Diffusion Electrodes,” filed on Nov. 5, 2002, which is hereby incorporated in its entirety.

For processing, a layer of an electrode composition can comprise liquid processing aids. In some embodiments, the liquid is an aqueous liquid, such as water. If a surfactant is used, the surfactant is generally soluble in the liquid. Some or all of the liquid is ultimately removed to leave a porous structure that is at least gas permeable. The use of liquid processing aids is described further in the above noted patent application entitled “Gas Diffusion Electrodes.”

For the formation of the active layer, the porous matrix polymer/catalyzed carbon mixture can be impregnated with a solid ion-conducting polymer so as to fill the pores of the matrix polymer. In some embodiments, substantially all of the pores of the matrix polymer are filled with an ion-conducting polymer. In other embodiments, the pores of the matrix polymer are only partially filled with the ion-conducting polymer. One method for impregnating the pores of the matrix polymer with an ion-conducting polymer comprises dissolving the ion-conducting polymer in a solvent and subsequently coating the surface of the matrix polymer/catalyzed carbon paste with the solvent/ion-conducting polymer mixture. The contact with the solution results in the deposition of the ion-conducting polymer in the pores of the matrix polymer. For processing of the active layer, the choice of solvent used to dissolve the ion-conducting polymer will be generally determined by the particular ion-conducting polymer and matrix polymer being employed. In some embodiments, the solvent(s) used during processing can be removed, for example, by evaporation, such that the final electrode compositions will be substantially free of solvents.

Alternatively or additionally, the ion-conducting polymer can be introduced during the formation of the active layer such that it naturally is disposed within the pores of the matrix polymer when the layer is formed. For example, in some embodiments, a mixture is formed by mixing the matrix polymer, catalyst particles, such as catalyzed carbon and/or other catalyst particles, and/or electrically conducting particles, with an ion-conducting polymer in the presence of a liquid lubricant. A matrix polymer, e.g. Teflon®, could be added to promote binding of the catalyzed carbon/ion-conducting polymer blend. The matrix polymer/catalyzed carbon/ion-conducting polymer blend can then be further processed into a sheet or other desired shape for use as the active layer in electrode compositions.

In general, the backing layer can be attached to the matrix polymer before or after the ion-conducting polymer/solvent mixture is applied to the matrix polymer. Depending on the presence of the ion-conducting polymer, the processing conditions for the attachment of the backing layer to the active layer can be selected appropriately. If the active layer and backing layer are separately formed, the backing layer and the active layer can be laminated together, for example, by calendering and/or by an adhesive. Alternatively or additionally, the active layer, which in one embodiment comprises an ion-conducting polymer, a matrix polymer and a catalyst, can be co-extruded with the backing layer.

The electrode assembly can then be assembled into a cell. Formation of a cell generally involves assembly of two electrode assemblies to function as an anode and a cathode with a separator between the two electrode assemblies. A separator can be integral with one electrode assembly and can be positioned appropriately to separate the anode and cathode of a cell. The separator is an electrically insulating structure. Suitable commercial materials for formation of separators include, for example, Freudenberg FS-2224-R, a polypropylene non-woven cloth (Freudenberg Group of Companies), Freudenberg FS-2115, a polyamide non-woven cloth, Crane CC21.0, a polyethylene sulfide non-woven cloth, Hollingsworth & Vose BP5053-W, a polyethylene/polypropylene mixture non-woven cloth (Hollingsworth & Vose Company, East Warpole, Mass.) UCB Cellophane, a poly non-woven cellophane cloth (UCB Cellophane Ltd., UK) Celgard 3401, polypropylene with a surfactant microporous membrane (Celgard Inc., Charlotte, N.C.); and CN 20/20, an acrylate grafted polyethylene non-porous membrane.

In some embodiments, the structure and/or composition of the anode and the cathode are different from each other. One or more cell structures can be placed within a housing along with an electrolyte. The current collectors are generally connected for parallel or series connection of the cells.

An advantage of fuel cells relative to traditional power sources such as lead acid batteries is that they can provide longer term primary and/or auxiliary/backup power more efficiently and compactly. This advantage stems from the ability to continuously refuel the fuel cells using fuel stored with the fuel cell, from some other source, and/or regenerated from reaction products using a regeneration unit. In the case of metal fuel cells, for example, the duration of time over which the energy can be provided is limited only by the amount of fuel and reaction medium which is initially provided in the fuel cell storage unit, which is fed into the system during replacement of a fuel cell storage unit, and/or which can be regenerated from the reaction products that are produced. Thus, a fuel cell system comprising at least one fuel cell that comprises an optional regeneration unit and/or replacement fuel storage unit, can provide auxiliary/backup power to one or more loads for a time in the range from about 0.01 hours to about 10,000 hours, or even more.

Fuel cells may be used to power a load which, as used herein, includes, for example and without limitation, telecommunications equipment, Internet servers, corporate mail servers, routers, power supplies, computers, test and industrial process control equipment, alarm and security equipment, many other types of electrical devices, equipment for which a power source is necessary or desirable to enable the equipment to function for its intended purpose, and the like, and suitable combinations of any two or more thereof. Additional examples of loads include lawn & garden equipment; radios; telephone; targeting equipment; battery rechargers; laptops; communications devices; sensors; night vision equipment; camping equipment (stoves, lanterns, lights); lights; vehicles (both primary and auxiliary power units, with or without regeneration unit on board, and with or without capability of refueling from a refueling station, including without limitation, cars, recreational vehicles, trucks, boats, motorcycles, motorized scooters, forklifts, golf carts, lawnmowers, industrial carts, passenger carts (airport), luggage handling equipment (airports), airplanes, lighter than air crafts (e.g., blimps, dirigibles, etc.,), hovercrafts, trains (locomotives), and submarines (manned and unmanned); torpedoes; and military-usable variants of above.

Structure For Zinc-Air Fuel Cell

A metal-air fuel cell involves oxidation of metal at the cathode and reduction of oxygen at the anode. The metal can be replenished such that the cell can continue to function indefinitely. Thus, the fuel cell system comprises a metal delivery section that can be operably connected with the fuel cell. The fuel cell unit comprises at least one anode and cathode spaced apart with a separator, which are all in contact with an electrolyte. Generally, the fuel cell unit is in a housing that provides for appropriate air-flow, maintenance of the electrolyte, connection with the metal delivery section and electrical contact to provide electrical work.

A particular embodiment of a zinc-air fuel cell system 100 is shown in FIG. 2. The zinc-air fuel system 100 comprises a zinc fuel tank 102, a zinc-air fuel cell stack or power source 104, an electrolyte management unit 106, a piping system 108, one or more pumps 110, and one or more valves (not shown) that define a closed flow circuit for the circulation of zinc particles and electrolyte during fuel cell operation. The zinc fuel tank 102, the electrolyte management unit 106, or a combination of these and/or other system components, may be a separable, detachable part of the system 100.

Zinc pellets in a flow medium, such as concentrated potassium hydroxide (KOH) electrolyte solution, are located in the zinc fuel tank 102. In another implementation, the particles can be a type of metal other than zinc, such as aluminum (aluminum-air fuel cell), lithium (lithium-air fuel cell), iron (iron-air fuel cell), or a particulate material other than metal that can act as an oxidant or redjictant. In other embodiments, the flow medium is a fluid, e.g., liquid or gas, other than an electrolyte.

The zinc and electrolyte solution can be, for example, pulsed, intermittently fed, or continuously fed from the zinc fuel tank 102, through the piping system 108, and into an inlet manifold 112 of the cell stack 104. Piping system 108 can comprise one or more fluid connecting devices, e.g., tubes, conduits, elbows, and the like, for connecting the components of system 100.

Power source 104 comprises a stack of one or more bipolar cells 114, each generally defining a plane and coupled together in series. Each cell 114 has an open circuit voltage determined by the reduction and oxidation reactants within the cell along with the cell structure, which can be expressed as M volts. Assuming that the open circuit potential of all the cells are equal, power source 104 has an open-circuit potential P equal to M volts×N cells, where N is the number of cells in power source 104.

Zinc-air fuel cell 114 interfaces with a fuel cell frame or body 136. The fuel cell body 136 generally forms a fuel cell cavity 137. Each cell 114 includes an air positive electrode or cathode 132 that occupies can entire surface or side of cell 114 and a zinc negative electrode or anode 134 that occupies an opposite entire side of cell 114. The cathode and anode are separated by an electrically insulating separator. A porous and electrically conductive film may be inserted between the electrodes 132, 134 of adjacent cells such that air can be blown through the film for supplying oxygen to each air positive electrode 132.

The bipolar stack 104 may be created by simply stacking cells 114 such that the current collector of negative electrode 134 of each cell is in physical contact with the positive electrode surface 132 of adjacent cell 114, with the porous and electrically conductive substance there between. With this structure, the resulting series connection provides a total open circuit potential between the first negative electrode 134 and the last positive electrode 132 of P volts. With these structures, extremely compact high voltage bipolar stacks 104 can be constructed. Furthermore, since no wires are used between cells 114 and since electrodes 132, 134 comprise large surface areas, the internal resistance between cells is extremely low.

The interface between one positive electrode 132 and piping system 108 through inlet manifold 112 is shown in phantom lines in FIG. 2. Inlet manifold 112 can run through cells 114 of power source 104, for example, perpendicular to the planes defined by the cells. Inlet manifold 112 distributes fluidized zinc pellets to cells 114 via conduits or cell filling tubes 116. Each inlet conduit 116 lies within its respective cell 114.

The zinc particulates and electrolyte flow through a flow path 115 in each cell 114, generally within the plane of the cell. The method of delivering particles to the cells 114 is a flow-through method. A dilute stream of pellets in flowing KOH electrolyte is delivered to the flow path 115 at the top of the cell 114 via conduit 116. The stream flows through flow path 115, across the zinc particle bed, and exits on the opposite side of cell 114 via outlet tube 118. Some of the pellets in the stream are directed by baffles 140 into electroactive zone 119. Pellets that remain in the flow stream are removed from cell 114. This flow through method, along with baffles 140, allows the electroactive zone 119 to occupy substantially all of the cell cavity and remain substantially constantly filled with zinc particles. As a result, the electrochemical potential of each cell 114 is maintained at desired levels per cell cavity volume. Pumps 110 can be used to control the flow rate of electrolyte and zinc through system 110. The fuel cell cavity communicates with inlet manifold 112 via cell filling tube 116.

As the zinc particles dissolve in electroactive zone 119 of cell 114, a soluble zinc reaction product, zincate, is produced. The zincate passes through a screen mesh or filter 122 near a bottom 123 of cell 114 and is washed out of the active area of cell 114 with electrolyte that also flows through cell 114 and filter 122. Screen mesh or filter 122 causes the electrolyte that exits cell 114 to have a negligible amount or no zinc particles. The flow of electrolyte through cell 114 not only removes the soluble zinc reaction product and, thereby, reduces precipitation of discharge products in the electrochemical zone 119, it also removes unwanted heat, helping to prevent cell 114 from overheating.

Electrolyte exits cell 114 and cell stack 104 via an electrolyte outlet conduit 128 and electrolyte manifold 130, respectively. The electrolyte is drawn into electrolyte management unit 106 through piping system 108. A pump (not shown) may be used to draw electrolyte into the electrolyte management unit 106. Electrolyte management unit 106 can be used to remove zincate and/or heat from the electrolyte so that the same electrolyte can be added to the zinc fuel tank 102 for zinc fluidation purposes. Electrolyte management unit 106, like zinc fuel tank 102, may be part of an integral assembly with the rest of system 100, or it may be a separate, detachable part of system 100.

A constant supply of oxygen is required for the electrochemical reaction in each cell 114. To effectuate the flow of oxygen, one embodiment of system 100 can include a plurality of air blowers 124 and an air outlet 126 on the side of cell stack 104 to supply a flow of air comprising oxygen to the positive air electrodes/cathodes of each cell 114. A porous substrate such as a nickel foam may be disposed between each cell 114 to allow the air to reach the air cathode of each cell and to flow through the stack 104. In other embodiments, an oxidant other than air, such as pure oxygen, bromine or hydrogen peroxide, can be supplied to a cell 114 for the electrochemical reaction.

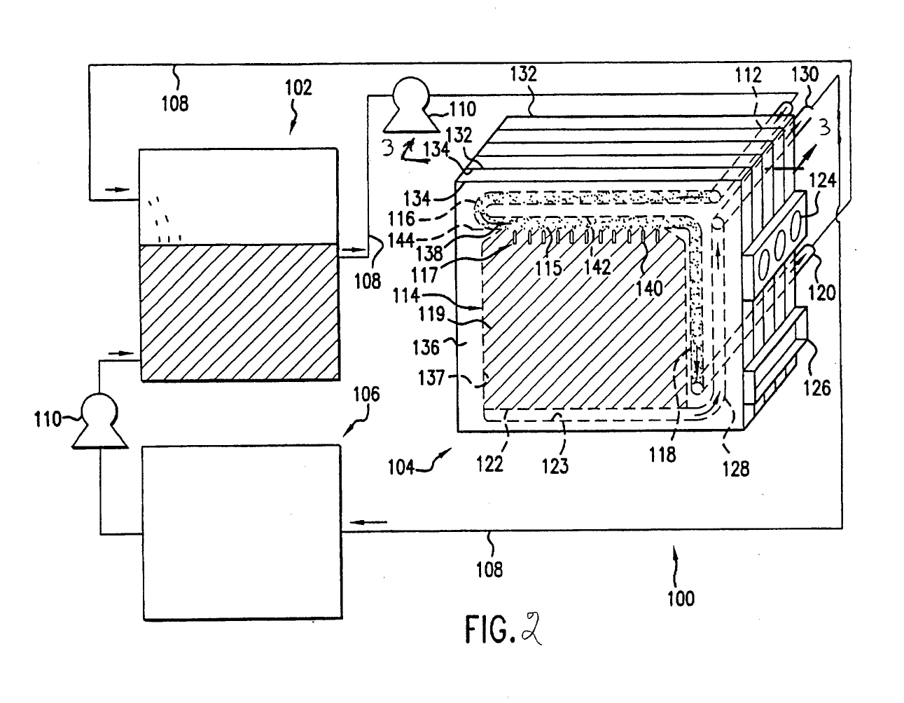

A sectional view of system 100 in FIG. 3 displays a positive air electrode/cathode 132 within one cell 114 of cell stack 104. Positive air electrode 132 is held with cell 114 within fuel cell frame 136. A non-porous divider 160 separates gas inflow from air blowers 124 from air outlets 126. Frame 136 forms an inlet chamber 162 and an outlet chamber 164. Inlet chamber 162 and outlet chamber 164, respectively, form passageways from positive air electrode 132 to air blowers 124 and air outlets 126. A gas permeable membrane 166 can be placed between air chambers 162, 164 and electrode 132 to reduce or prevent loss of electrolyte through flow out of the cell and/or evaporation.

While certain configuration of the positive air electrode/cathode are suitable for use in the fuel cell of FIG. 2, a broader range of gas diffusion electrode structures are generally useful and are described further below.

Electrode Assembly Structure And Materials

The electrode assembly of the present invention generally comprises an active layer attached to a backing layer. The active layer comprises catalyst particles for catalyzing the electrode reactions. Generally, the electrochemical reactions take place in the active layer, and the backing layer permits reactants, generally gases, to permeate to the active layer. The backing layer can also prevent the electrolyte from diffusing out of the active layer through the backing layer. In some embodiments, the electrode assembly also comprises a current collector and a separator. A current collector generally functions to reduce the overall electrical resistance of the electrode assembly, while the separator provides a means for electrically separating the components of the electrode. While the electrodes described herein are useful as positive electrodes for the reduction of molecular oxygen, they can also be useful as cathodes and/or anodes based on gaseous or liquid reactants.

The active layer of a gas diffusion electrode generally comprises a first polymer, a catalyst and an ion-conducting polymer instilled within the pores of the first polymer. The electrode composition can also comprise electronically conductive particles held together by the first polymer. The electrode composition can further comprise additional materials to facilitate processing and/or to form a structure with desired properties. The electrode composition can be formed into an electrode assembly by combining the electrode composition with a current collector and/or additional electrode layers. The electrode composition typically is formed into a structure with a generally planar aspect with a thickness that is significantly smaller than the dimensions across the face of the planar structure. As described further below, the electrode composition can comprise a solid phase and a fluid phase.

The structure of the gas diffusion electrode can be generalized to provide for multiple functionalities. For example, multiple different catalysts can be added to the active layer. As an example, the active layer can include catalysts suitable for oxygen reduction, such as platinum, and for oxygen generation, such as NiO or a perovskite, such as La_{0.5}Sr_{0.5}CoO₃. Alternatively or additionally, different catalysts can be placed in adjacent active layers within an electrode. Thus, for example, an active layer with the catalysts for oxygen evolution can be placed adjacent the electrolyte and an active layer with catalysts for oxygen reduction can be placed between the first active layer and the backing layer. In general, the gas diffusion electrode can comprise two, three or more active layers. Any one or more of the active layers can comprise the ion-conducting polymers described herein.

In some embodiments, for the formation of an active layer, the solid phase of the electrode composition generally comprises in the range(s) from about 5 weight percent to about 50 weight percent of polymer and in further embodiments, in the range(s) from about 10 weight percent to about 35 weight percent. In additional embodiments, for the formation of an electrode backing layer, the solid phase of the cathode composition generally comprises in the range(s) from about 40 weight percent to about 90 weight percent polymer. A person of ordinary skill in the art will recognize that additional ranges within these explicit ranges are contemplated and are within the present disclosure.

In general, the matrix polymer can be any polymer suitable for forming a porous particle binder. The matrix polymer can be a homopolymer, copolymer, block copolymer or a polymer blend or mixture. Suitable matrix polymers include, but are not limited to, poly(ethylene), poly(tetrafluoroethylene), poly(propylene), and poly(vinylidene fluoride). Other suitable matrix polymers include styrene block copolymers including, for example, styrene-isoprene-styrene, styrene-ethylene-butylene-styrene and styrene-butadiene-styrene. Suitable styrene block copolymers are sold under the trade name KRATON®.

For the processing of the cathode material by calendering and/or extrusion, the matrix polymer can be a fibrillatable polymer. Suitable fibrillatable polymers include, for example, polytetrafluoroethylene (e.g., Teflon®9B, 602A, 610A, 612A, 640, K-10, CFP6000, 60, 67, and NXT (DuPont), Halon™ and Algoflon™ (Ausimont USA), Fluon™ (ICI America Inc.), Hostaflon™ (Hoechst Celanese) and Polyflon™ (Daikan)), polyproplyene, polyethylene (generally high or ultrahigh molecular weight), ethylene-tetrafluoroethylene copolymer (e.g., Tefzel™ (DuPont) and Halon™ ET (Ausimont, USA)), fluorinated ethylene propylene copolymer (e.g, as sold by DuPont), ethylene-chlorotrifluoro ethylene copolymer (e.g., Halar™ (Ausimont USA)), perfluoroalkoxy (e.g., as sold by DuPont), and blends or combinations thereof. In some embodiments of interest, fibrillatable polymers are supplied for forming the electrode composition with average particle sizes in the range(s) from about 0.1 microns to about 500 microns. A person of ordinary skill in the art will recognize that additional ranges within this explicit range of particle sizes are contemplated and are within the present disclosure.

For compression molding processing of the electrode composition, fibrillatable polymers may or may not be used. Suitable matrix polymers for compression molding include, for example, epoxies, styrene-poly(ethylene-butylene)-styrene triblock copolymer (e.g., Kraton®G (Shell)), styrene-butadiene-styrene triblock copolymer (e.g., Kraton®D (Shell)), phenolics (supplied by Capital Resins Corp.), modified polyphenylene oxide-styrene Noryl® supplied by General Electric), polytetrafluoroethylene (e.g., Teflon®9B, 602A, 610A, 612A, 640, K-10, CFP6000, 60, 67, and NXT (DuPont), Halon™ and Algoflon™ (Ausimont USA), Fluon™ (ICI America Inc.), Hostaflon™ (Hoechst Celanese) and Polyflon™ (Daikan)), modified ethylene chlorotrifluoroethylene (Vataro, Ausimont USA), polyfurans (QO Chemicals), melamine (Oxidental Chemical), perfluoromethylvinylether (Hyflon®, Ausimont USA) and perfluoroalkoxy (Hyflon®, Ausimont USA). For metal-air cell applications, the polymers generally are selected to be relatively chemically inert after long exposure to high concentrations of OH⁻ at elevated temperatures and in the presence of electric fields.

In some embodiments, the active layer of the present invention comprises an ion-conducting polymer instilled within the pores of the matrix polymer. Any suitable polymeric material that can act as an ion-conducting membrane can potentially be used. Suitable materials for the ion-conducing polymer of the present invention include sulfonated, phosphonated or carboxylated ion-conducting aromatic polymers that produce cation or proton exchange polymers, or aromatic polymers with a benzenetrimethylammonium hydroxide functionality or similar derivatives that produce anion or hydroxide exchange polymers. Other suitable anion-conducting polymers can be produced from amination of polyvinylpyrrolidone (PVP) or fluorinated ethylenepropylene (FEP). Suitable aromatic polymers include, but are not limited to, polysulfone, polyimide, polyphenylene oxide, polyphenylene sulfoxide, polyphenylene sulfide, polyphenylene sulfide sulfone, polyparaphenylene, polyphenylquinoxaline, polyarylketone and polyetherketone.

Other suitable ion-conducting polymers include polystyrene sulfonic acid, polytrifluorostyrene sulfonic acid, polyvinyl phosphonic acid, polyvinyl carboxylic acid and polyvinyl sulfonic acid polymers. Perfluorinated sulfonic acid membranes can also be used as the ion-conducting polymer. One suitable perfluorinated sulfonoic acid membrane is sold under the trade name Nafion® by E.I. Dupont de Nemours and Co. Other suitable commercially available ion-conducting membranes include Aciplex® (Asahi Chemical Industry), Flemion® (Asahi Glass KK) and Gore-Select® (W.L. Gore). Examples of suitable anion exchange membranes are sold as ULTREX™ AMI-7001 supplied by Membranes International or FILMTEC™ membrane from Dow Chemical. In addition, the ion-conducting polymer of the present invention can also be a suitable copolymer or blend of any two or more of the polymers list above.

For electrode compositions that contain an ion-conducting polymer, the solid phase of the electrode composition generally can comprise no more than about 50 weight percent of the ion-conducting polymer relative to the total solid phase mass including the ion-conducting polymer. In some embodiments, from about 5 weight percent to about 25 weight percent of the solid phase of the electrode composition is ion-conducting polymer. In further embodiments, the solid phase of the electrode composition comprises from about 10 weight percent to about 20 weight percent ion-conducting polymer.

For active electrode compositions, the solid phase of the electrode composition generally can comprise no more than about 80 weight percent electrically conductive particles and in further embodiments from about 20 weight percent to about 70 weight percent electrically conductive particles. For electrode backing layers, the solid phase of the electrode composition generally can comprise in the ranges from about 0 weight percent to about 50 weight percent electrically conductive particles and in further embodiments from about 5 weight percent to about 40 weight percent electrically conductive particles. A person of ordinary skill in the art will recognize that other ranges of amounts of electrically conductive particles are contemplated and are within the present disclosure.

The electrically conductive particles can comprise carbon conductors, such as carbon black, other carbon particles, metal particles, conductive metal compounds, conductive ceramics, or combinations thereof. Electrically conductive particles of particular interest comprise carbon black with a BET (Brunauer-Emmett-Teller) surface area in the ranges of at least about 200 m²/g, and in other embodiments from about 300 m²/g to about 1500 m²/g. A person of ordinary skill in the art will recognize that additional ranges of surface areas within the explicit ranges are contemplated and are within the present disclosure. Suitable carbon blacks generally include, for example, acetylene blacks, furnace blacks, thermal blacks and modified carbon blacks. Commercial carbon blacks generally are sold with specified BET surface areas, as measured by accepted ASTM test procedures. In addition, the carbon blacks can have an electrical resistivity as measured by accepted techniques by carbon black vendors of no more than about 0.01 ohm-cm. Furthermore, the carbon black may have an internal volume as determined by a DBP (dibutyl phthalate) absorption test of at least about 150 cm³/100 gm, and in other embodiments at least about 300 cm³/100 gm, wherein the internal volume is determined as set forth in standard test procedure ASTM D-2414-79. Specific suitable carbon blacks include, for example, ABC-55 22913 (Chevron Phillips, Houston, Tex.), Black Pearls (Cabot, Billerica, Mass.), Ketjen Black (Akzo Nobel Chemicals Inc., Chicago, Ill.), Super-P (MMM Carbon Division, Brussels, Belgium), Condutex 975® (Columbia Chemical CO., Atlanta, Ga.), Printex XE (Degussa Corp., Ridgefield Park, N.J.) and mixtures thereof. In general, the electrically conductive particles, for example, carbon black, can be spherical, rod-shaped or any other suitable shape or combinations of shapes yielding an appropriate surface area and conductivity. For electrode applications, carbon black properties of particular interest include, for example, electrical conductivity, porosity and hydrophobicity. The characteristics and concentration of electrically conductive particles are generally selected to provide low electrical resistance, which is generally thought to result from obtaining conditions exceeding a percolation threshold, although not wanting to be limited by theory. Factors that influence electrical conductivity of electrical particles in a matrix include, for example, geometry of the matrix, crystallinity of the matrix, interactions between the electrical particles and the matrix, size and shape of the particles, surface area, degree of dispersion and concentration.

In general, the particulate components need not be homogenous materials, and may be blends of materials, such as blends varying in particle size, shape and/or surface area, which can be used to impart desired electrical, physical and processing properties.

While the electrically conductive particles may also function as catalysts for the reduction of molecular oxygen, generally a specific catalyst material is added to an active electrode layer. Catalysts, as described herein, broadly cover any material(s) that can catalyze a reduction-oxidation reaction. If two materials each provide electrical conductivity and catalytic activity, it may be arbitrary, which is called electrically conductive particles and which is called a catalyst. However, it may be desirable to add one material primarily as a catalyst and a second material primarily as an electrically conductive material. In some embodiments, the solid phase of the electrode composition can comprise in the range(s) less than about 50 weight percent, in other embodiments in the range(s) from about 45 weight percent to about 5 weight percent and in further embodiments in the range(s) from about 10 weight percent to about 40 weight percent. A person of ordinary skill in the art will recognize that additional ranges within these explicit ranges are contemplated and are within the present disclosure. Suitable catalysts include, for example, elemental metal particles, metal compositions and combinations thereof. Suitable metals broadly cover all recognized metal elements of the periodic table and alloys thereof. Exemplary metals include without limitation, Fe, Co, Ag, Ru, Mn, Zn, Mo, Cr, Cu, V, Ni, Rh, and Pt. Suitable metal compositions include, for example, permanganates (e.g., AgMnO₄ and KMnO₄), metal oxides (e.g., MnO₂ and Mn₂O₃), decomposition products of metal heterocycles (e.g., iron tetraphenylpoiphyrin, cobalt tetramethoxyphenylporphyrin, cobalt complexes (e.g., tetramethoxyphenyl porphyrin (CoTMPP)), perovskites, cobalt pthalocynanine and iron pthalocynanine) and napthenates (e.g., cobalt napthenates and manganese napthenate) and combinations thereof. Elemental metals are un-oxidized metals in their zero oxidation state, i.e., Mo. Suitable elemental metal particles include, for example, Ag, Pt, Pd, Ru, alloys thereof and combinations thereof. In general, the catalyst particles can be spherical, rod-shaped or any other suitable shape or combinations of shapes yielding an appropriate surface area.

Some metals for use as catalysts have a high cost. Therefore, cost savings can result from coating the elemental metal onto a less expensive particulate. For example, metals can be coated onto carbon black. In some embodiments, the catalysts comprise in the range(s) of at least about 80 weight percent carbon black and no more than about 20.0 weight percent metal, and in other embodiments from about 94.95 weight percent to about 99.9 weight percent carbon black, in the range(s) from about 0.1 weight percent to about 5.0 weight percent metal and in the range(s) from about 0.05 to about 5 weight percent nitrogen. To form the catalyst, carbon black is contacted with vapors of metal precursors and nitrogen precursors in a reducing environment. The metal may or may not be in elemental form and the carbon black may or may not be chemically bonded to metal and/or the nitrogen. The carbon black materials described above are also suitable for forming these catalyst materials. The carbon black-metal-nitrogen containing catalysts are further described in copending and commonly assigned U.S. patent application Ser. No. 09/973,490 to Lefebvre, entitled “Methods of Producing Oxygen Reduction Catalyst,” incorporated herein by reference.

The electrode can optionally comprise additional materials, generally each at a concentration of no more than about 5 weight percent. Potential additional materials include, for example, fillers, processing aids, stabilizers and the like and combinations thereof. Additionally, in some embodiments of the present invention the electrode composition comprises a friction reducing or anti-wear agent as a processing aid.

In general, active layers are more hydrophilic than the backing layers. For example, the backing layers can be essentially pure polymers that are hydrophobic, such as polytetrafluoroethylene, polyethylene, polypropylene, poly(vinylidene fluoride) or mixtures thereof. Generally, the active layer is sufficiently hydrophilic to provide for movement through the layer of electrolyte and ionic species. The backing layer is generally sufficiently porous to allow gasses, for example oxygen, to diffuse through it, while also being sufficiently hydrophobic to prevent liquids such as electrolytes from passing through. In some embodiments, the backing layer can comprise particles, such as electrically conductive particles, within a porous water resistant composite.

For formation of an electrode, the electrode composition generally is formed into a sheet shape with a thickness much less than the linear dimensions defining the extent of the planar surfaces of the electrode. In some embodiments, the electrode has an average thickness in the range(s) of no more than about 5 millimeters (mm), in additional embodiments in the range(s) of no more than about 3 mm, in other embodiments in the range(s) of no more than about 2 mm, in further embodiments in the range(s) from about 1.5 mm to about 0.05 mm and in additional embodiments in the range(s) from about 1 mm to about 0.01 mm. A person of ordinary skill in the art will recognize that additional ranges of electrode thickness and uniformity within these explicit ranges are contemplated and are within the present disclosure.

The thickness may or may not be approximately constant across the face of the electrode. In some embodiments, the smallest edge-to-edge distance across the face of an electrode through the center of the electrode face is at least about 1 centimeter (cm). The shape of the face of the electrode can have any convenient shape, such as circular, oval or rectangular, for assembly into a galvanic cell or other device. In some embodiments, the electrode is roughly rectangular, although one or more of the edges may not be straight and one or more of the comers may or may not be square. For assembly into some embodiments of commercial fuel cells, it is desirable to have the smallest edge-to-edge distance across the face of the electrode though the center of the electrode to be in the range(s) of at least about 1 cm, in other embodiments in the range(s) of at least about 10 cm and in further embodiments in the range(s) from about 14 cm to about 200 cm. A person of ordinary skill in the art will recognize that additional ranges of electrode dimensions are contemplated and are within the present disclosure.

A current collector is a highly electrically conductive structure that is combined with the active layer and/or backing layer to reduce the overall electrical resistance of the electrode assembly. Suitable current collectors can be formed from elemental metal or alloys thereof, although they can, in principle be formed from other materials. While in some embodiments a metal foil or the like can be used as a current collector, for gas diffusion electrodes, it is generally desirable to have a current collector that is permeable to the gaseous reactants such that the gas can flow through the cell. Thus, in some embodiments, the current collector comprises a metal mesh, screen, wool or the like. Suitable metals for forming current collectors that balance cost and convenience include, for example, nickel, aluminum and copper, although many other materials, metals and alloys can be used, as noted above. The current collector generally extends over a majority of the face of the electrode composition and may comprise a portion that extends beyond the electrode composition, for example, a tab that can be used to make an electrical connection to the current collector.

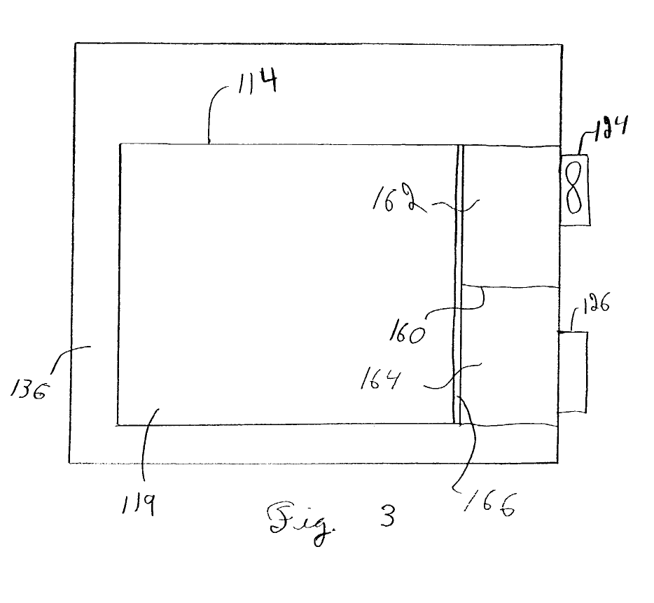

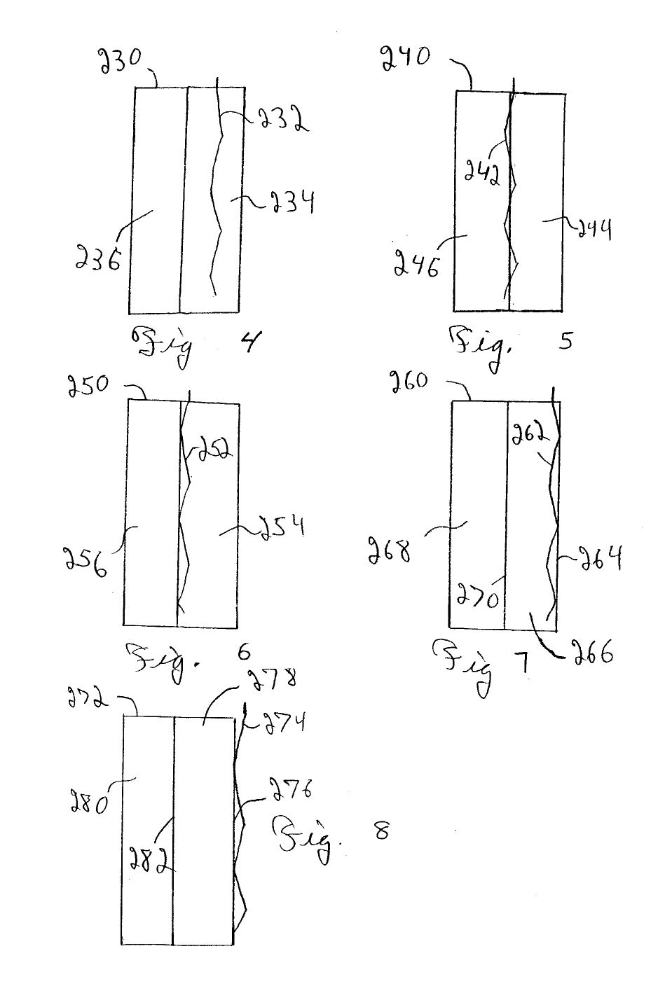

In some embodiments, the electrode assembly comprises a plurality of layers with different electrode compositions, such as an active electrode layer and/or an electrode backing layer, a plurality of active electrode layers and/or a plurality of electrode backing layers. The current collector can be placed in several positions within the electrode assembly. Some representative structures are shown in FIGS. 4-8. Referring to FIG. 4, electrode assembly 230 comprises a current collector 232 embedded within an active layer 234 and a backing layer 236 adjacent the active layer 234. Referring to FIG. 5, electrode assembly 240 comprises a current collector 242 embedded approximately within an active layer 244 and a backing layer 246 at the interface between electrode compositions 244, 246. Referring to FIG. 6, electrode assembly 250 comprises a current collector 252 embedded below a face an active layer 254 and a backing layer 256 adjacent the same face of the active layer 254. Referring to FIG. 7, electrode assembly 260 comprises a current collector 262 embedded below a first face 264 of an active layer 266 and a backing layer 268 adjacent second face 270 of the active layer 266. Referring to FIG. 8, electrode assembly 272 comprises a current collector 274 attached to a first face 276 of an active layer 278 and a backing layer 280 adjacent a second face 282 of the active layer 278. Additional or alternative embodiments comprising a plurality of active electrode layers, a plurality of electrode backing layers and/or a plurality of current collectors can be formed by straightforwardly generalizing the basic structures shown in FIGS. 4-8.

The Gurley number is a measurement of the porosity of a material. Lower values of Gurley numbers reflect a greater porosity, as described further below. Gurley numbers of at most about 200 can be desirable in some embodiments for an electrode backing layer. Generally, the electrode assembly can be gas permeable without the presence of the ion-conducting polymer, although with the presence of the ion-conducting polymer, the electrode assembly may not be gas permeable. Gurley number can be evaluated, for example, with an instrument from Gurley Precision Instruments, Troy, N.Y.

Processing To Form Electrode Assembly

The processing of the electrode composition and/or the electrode assembly comprises combining the components of the electrode composition, forming the desired electrode structure(s) and optionally combining components to form an electrode assembly. In general, an electrode assembly comprises an active layer, a backing layer, and optionally a current collector. For the processing of a layer, the formation of a fibrillated structure using a fibrillatable matrix polymer generally comprises the application of sufficient shear to result in the desired fibrillation. The fibrillation can result in desired porosity while obtaining desired mechanical properties of the electrode composition and good binding of particulates. The desired shear can be applied in one or more steps that can comprise, for example, high shear mixing, extruding and/or calendering. At least some of the shaping of the electrode composition can be performed simultaneously with the application of the shear. Additionally or alternatively, the electrode composition can be shaped using molding, such as compression molding. Similar approaches can be used to simultaneously process the active and backing layers following formation of the combined structure, for example, by coextrusion.

In some embodiments, the electrode composition can comprise a fluid phase and a solid phase. The fluid phase comprises a fluid and, optionally, compositions dissolved within the fluid. The solid phase includes everything not in the fluid phase. The fluid phase can be, for example, a liquid or a gas that diffuses out by applying suitable conditions, such as heat, or by dissolution of the fluid from the electrolyte. In some embodiments, the electrode composition comprises a weight ratio of fluid phase to solid phase in the range(s) of no more than about 20.0, in other embodiments, in the range(s) of no more than about 10.0, and in further embodiments in the range(s) from about 9.0 to about 0.05 and in some embodiments in the range(s) from about 3.5 to about 1.5. A person of ordinary skill in the art will recognize that additional range(s) within these explicit ranges are contemplated and are within the present disclosure. The electrode composition can have a greater ratio of fluid to solid during the mixing stages relative to the other stages of processing. At the completion of the electrode preparation, the electrode may or may not be devoid of fluid. In some embodiments, the electrode following drying may have no more than about 5 weight percent liquid.

Generally, the components of the electrode compositions are combined and mixed, although not all components need to be combined simultaneously. In some embodiments, the ion-conducting polymer is mixed with the matrix polymer, the catalyst, optional processing aids and conductive material to form the active layer in a single step. In other embodiments, the catalyst, the matrix polymer and optionally other processing aids are mixed and processed to form a porous sheet and the ion-conducting polymer is applied to the active layer following formation of the active layer. Before mixing, the powders can be pulverized, for example, using an air impact pulverizer. Suitable air impact pulverizers include, for example, Tost Model T-15 manufactured by Plastomer Technologies (Newton, Pa.) or a Rotomill model 1000 or model 1300 manufactured by International Process Equipment Co. (Pennsauken, N.J.). The formation of the backing layer can be similar to the formation of the active layer except that the backing layer does not include catalyst particles.

In some embodiments, the matrix polymer can result in a high viscosity of the combined electrode composition such that the mixing requires considerable shear to combine the ingredients. The mixing can be performed in corresponding mixing apparatuses that can impose the corresponding shear. For example, the mixing or a portion thereof can be performed in a blender or a mill or the like. Generally, the mixture is mixed for sufficient time to form an approximately homogenous paste. The specific amount of time can be selected based on the particular equipments and processing conditions. Liquid components can be added or removed at one or more points in the processing and can be added to replace liquid lost during processing and/or to alter the processing properties.

Following the blending of the solid components, the electrode composition can be shaped. In some embodiments, the mixture is extruded through a die. Various extruders can be used, such as a twin screw extruder, a ram extruder and the like. Suitable ram extruders include, for example, ram extruders from, for example, Jennings Corporation (Norristown, Pa.) or from WK Worek U.S.A. (Ramsey, N.J.). In some embodiments, the extrusion generally is performed at pressures in the range(s) of no more than about 50,000 psi gauge (psig), in other embodiments in the range(s) of no more than about 10,000 psig and in further embodiments in the range(s) from about 1,500 psig to about 6,000 psig. For ram extrusion, the corresponding velocity of the ram in the extruder can be in the ranges of at least about 3 cm/sec and in further embodiments from about 5 cm/sec to about 100 cm/sec. A person of ordinary skill in the art will recognize that additional ranges of extrusion pressures and ram velocities within the explicit ranges are contemplated and are within the present disclosure. The extrusion is performed through a die opening.

The die opening of the extruder can have any reasonable shape, such as a slit, a circle, an oval or the like. The size and shape of the die opening determines the characteristics of the electrode composition for further processing. While the die opening can have a variety of possible shapes, in some embodiments, the die has a shape of a rectangular slit with a dimension corresponding to the thickness of the extrudate in the range(s) of no more than about 3 cm, in other embodiments in the ranges of no more than about 5 millimeters (mm), and in additional embodiments in the range(s) from about 2.5 mm to about 0.05 mm. A person of ordinary skill in the art will recognize that additional ranges within these explicit ranges are contemplated and are within the present disclosure.

The extrusion can be performed at any temperature in which the electrode composition has a sufficiently low viscosity that the composition can be extruded to allow fibrillation of the matrix polymer system. In some embodiments, the extrusion is performed at room temperature or at an elevated temperature. In embodiment in which the extrusion is performed at an elevated temperature, the temperature can be in the range(s) from about 25° C. to about 150° C., in other embodiments in the range(s) from about 30° C. to about 80° C., and in further embodiments in the range(s) from about 40° C. to about 70° C. A person of ordinary skill in the art will recognize that additional ranges within these explicit ranges are contemplated and are within the present disclosure.

The mixing and optional extruding apply shear to the fibrillatable matrix polymer that can induce fibrillation of the polymer. In addition, in the some embodiments, extrusion can shape the electrode composition to have a particular thickness and shape or geometry. However, even in embodiments in which the electrode composition is extruded, it may be desirable to calender the electrode composition. Calendering broadly includes passing the composition through a gap, generally formed by opposing pairs of moving members. Suitable moving members include, for example, rollers, belts and the like.

The electrode shape and size are selected to be appropriate for the corresponding cell into which the electrode is placed. The electrodes materials can be selected and processed to produce electrodes with approximately the desired shape and size. In alternative embodiments, the electrodes can be cut to the desired sizes using available cutting tools.

Additionally or alternatively, electrode structures can be formed by compression molding. To perform the compression molding, the electrode materials are generally formed into a paste as described above using a mixer. The paste is then transferred to the mold of a compression molding apparatus. Compression molding has been used for the formation of electrodes for batteries using PTFE binders. See, for example, U.S. Pat. No. 6,413,678 to Hamamoto, et al., entitled “Non-Aqueous Electrolyte And Lithium Secondary Battery Using The Same,” U.S. Pat. No. 6,001,139 to Asanuma, et al., entitled “Nonaqueous Secondary Battery Having Multiple-Layered Negative Electrode, and U.S. Pat. No. 5,705,296 to Kamauchi, et al., entitled “Lithium Secondary Battery,” all three of which are incorporated herein by reference. An electrode structure comprising an active layer and a backing layer can be formed by placing the appropriate compositions adjacent each other in the mold.

In some embodiments, the ion-conducting polymer is dissolved into a solvent and then coated onto the porous matrix polymer/catalyst layer. Any appropriate means for coating can be used to apply the solvent/ion-conducting polymer mixture to the porous matrix polymer including spraying or submerging. In this embodiment, the solvent can be, for example, a suitable commercially available solvent that can dissolve the ion-conducting polymer. Generally, the choice of solvent will depend on the specific matrix polymer and ion-conducting polymer being used. In some embodiments, the solvent may be a polar solvent, such as water or a polar organic solvent. The solvent used to dissolve the ion-conducting polymer should be selected such that the solvent will not adversely affect or degrade the pores that have been formed in the matrix polymer. In some embodiments, a solvent for dissolving the ion-conducting polymer and/or a liquid processing aid for assisting with the processing of the matrix polymer may be present when the ion-conducting polymer/solvent mixture is applied to the porous layer. The solvent for the ion-conducting polymer and the processing aid may or may not be the same as a liquid processing aid for the processing of the mixture of the matrix polymer and catalyst particles. In these embodiments, the solvent used to dissolve the ion-conducting polymer generally is selected to be compatible with the other liquids and/or solvents present in the active layer as well as the matrix polymer and catalyst particles.

In other embodiments, the ion-conducting polymer is incorporated into the pores of the matrix polymer during processing of the matrix polymer. In this embodiment, suitable mixers, extruders and other processing apparatuses described above may be employed to produce the active layer composition. The desired proportion of the polymers and particles are combined to form the desired structure. In these embodiments, the ion-conducting polymer similarly may or may not fill all of the pores in the matrix polymer. The processing conditions can be selected to be appropriate for the ion-conducting polymer. For example, the temperature can be kept to values at which the ion-conducting polymer is stable.

In some embodiments, the electrode compositions will be dried to remove processing aids and solvents added during formation of the electrode. In embodiments that involve friction reducing agents or other processing aids, the drying step will permit the evaporation of these process aids as well as any solvent(s) used to form or process the electrode composition. As a result, some embodiments of the final electrode composition will be substantially free of solvents, processing aids and other fluids. In other embodiments, the electrode composition comprises less than about 5 weight percent processing aids, viscosity modifiers, stabilizers, solvents and the like and combinations thereof. In further embodiments, the electrode composition can comprise from about 5 weight percent to about 10 weight percent viscosity modifiers, stabilizers, processing aids and the like. In embodiments where the ion-conducting polymer is instilled into the pores of the matrix polymer by dissolving the ion-conducting polymer in a suitable solvent, the resulting active layer composition can be dried before or after the active layer is adhered to a backing layer.

The electrode composition can be associated with a current collector to form an electrode assembly. The electrode assembly can comprise various structures as described above. The association can be performed with an electrically conductive adhesive, such as a carbon particle-containing adhesive/polymer. Alternatively or additionally, the current collector can be associated with one or more electrode compositions by laminating the current collector to the electrode composition(s) for example in a press, with a calender apparatus or the like. Laminating the current collector with one or more electrode compositions may or may not result in a reduction of the thickness of the electrode composition. The lamination can be repeated, if necessary, to achieve a desired level of adhering of the current collector. Similarly, the pressure in a press and the gap dimensions of a calender can be selected to yield a desired level of adhering.

Furthermore, the electrode, with or without the current collector, can be associated with the backing layer and/or a separator. In some embodiments, it is desirable for the degree of adherence of the active layer to the backing layer to exceed the tensile strength of the materials of one or both of the layers themselves. In particular, the electrode can be combined with one or more of these other elements of an electrode assembly through lamination, for example, through a calender. Suitable roller speeds for this lamination are, for example, from about 0.01 rpm to about 10 rpm or in other embodiments from about 0.3 rpm to about 5 rpm, and suitable temperatures are in the range(s) from about 50° C. to about 330° C. A person of ordinary skill in the art will recognize that additional ranges within these particular ranges are contemplated and are within the present disclosure. If the ion-conducting polymer is present when the lamination is performed, the temperature can be selected such that the ion-conducting polymer is not adversely affected. The active layer can also be laminated to the backing layer, for example, through the use of a heat press or through calendering. One suitable heat press is the Carver Laboratory Press model 4128 (Carver, Inc.). Alternatively or additionally, the backing layer can be attached to the active layer with adhesives. Any commercially available adhesive, such as an electrically conducting adhesive, that does not interfere with the function of the electrode can potentially be used to attach the backing layer to the active layer.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

What we claim is:

1. A electrode assembly comprising an active layer and a backing layer adhered to the active layer, wherein the active layer comprises a catalyst, a matrix polymer and an ion-conducting polymer, the matrix polymer forming a porous polymer matrix and the ion-conducting polymer being within the pores of the polymer matrix, and the backing layer comprises a hydrophobic polymer and particles within a porous composite.

2. The electrode assembly of claim 1 wherein the ion-conducting polymer comprises an hydroxide ion exchange polymer.

3. The electrode assembly of claim 1 wherein the ion-conducting polymer comprises a proton exchange polymer.

4. The electrode assembly of claim 1 wherein the ion-conducting polymer comprises Nafion.

5. The electrode assembly of claim 1 the matrix polymer comprises a hydrophobic polymer.

6. The electrode assembly of claim 1 wherein the matrix polymer comprises the hydrophobic polymer of the backing layer.

7. The electrode assembly of claim 1 wherein matrix polymer comprises a fluoronated polymer.

8. The electrode assembly of claim 1 wherein the matrix polymer comprises a perfluoronated polymer.

9. The electrode assembly of claim 1 wherein the matrix polymer comprises polytetrafluoroethylene.

10. The electrode assembly of claim 1 wherein the catalyst comprises a noble metal.

11. The electrode assembly of claim 1 wherein the active layer further comprises conductive carbon.

12. The electrode assembly of claim 1 wherein the active layer and the electrode backing layer are adhered to each other with an adherence strength that exceeds the tensile strength of at least one of the layers.

13. The electrode assembly of claim 1 wherein the electrode backing layer has a Gurley number of at most about 200.

14. The electrode assembly of claim 1 wherein the active layer comprises at least about 10 weight percent ion-conducting polymer.

15. The electrode assembly of claim 1 further comprising a second active layer that comprises a second catalyst.

16. A fuel cell stack comprising a cathode, an anode, and a separator between the cathode and the anode, wherein the cathode comprises active layer and a backing layer adhered to the active layer, wherein the active layer comprises a catalyst, a matrix polymer and an ion-conducting polymer within the pores of a polymer matrix formed by the matrix polymer and the backing layer comprises a hydrophobic polymer and particles forming a porous composite.

17. The fuel cell stack of claim 16 wherein the anode comprises an elemental metal.

18. The fuel cell stack of claim 16 wherein the anode comprises zinc, an alloy of zinc or a combination thereof.

19. The fuel cell stack of claim 16 wherein the separator comprises a porous polymer.

20. The fuel cell stack of claim 16 further comprising an electrolyte comprising an aqueous base.

21. A fuel cell comprising a container and the fuel cell stack of claim 15 within the container.

22. The fuel cell of claim 21 wherein the container comprises a gas flow passage that provides for flow of gas to the cathode.

23. The fuel cell of claim 22 wherein the container comprises a fluid flow passage to the anode isolated from the gas flow passage.

24. The fuel cell of claim 23 wherein the anode comprises zinc, zinc alloy or a combination thereof.

25. A method for forming a electrode assembly comprising an active layer and a backing layer, the method comprising:
instilling an ion-conducting polymer within an active layer of the electrode assembly, and
laminating the backing layer to the active layer, the active layer comprising a catalyst and a matrix polymer in the form of a porous matrix into which the ion-conducting polymer is instilled and the backing layer comprising a hydrophobic polymer and particles within a porous water resistant composite.

26. The method of claim 25 wherein the ion-conducting polymer is instilled within the active layer after the active layer is laminated to the backing layer.

27. The method of claim 25 wherein the ion-conducting polymer is instilled within the active layer before the active layer is laminated to the backing layer.

28. The method of claim 25 wherein the instilling the ion-conducting polymer is performed by contacting the active layer with a solution comprising the ion-conducting polymer to form a composite with ion-conducting polymer within the pores of the active layer.

29. The method of claim 28 further comprising drying the composite to remove at least a portion of the solvent.

30. The method of claim 25 wherein instilling the ion-conducting polymer comprises blending the ion-conducting polymer, the matrix polymer and catalyst particles with a solvent to form a paste and casting the paste into a film.

31. The method of claim 30 wherein the casting of the paste is performed by extrusion.

32. The method of claim 30 wherein the casting of the paste is performed by calendering.

33. The method of claim 25 wherein the active layer further comprises electrically conductive carbon particles.

34. The method of claim 25 wherein the ion-conducting polymer is selected from the group consisting of sulfonated ion-conducting aromatic polymers, phosphonated ion-conducting aromatic polymers, carboxylated ion-conducting aromatic polymers, aromatic polymers with a benzenetrimethylammonium hydroxide functionality and aminated polymers that are anion conducting polymers.

35. The method of claim 25 wherein the matrix polymer comprises a fluoronated polymer.

36. The method of claim 25 wherein the backing layer comprises a fluoronated polymer.
